(19) United States
(12) Patent Application Publication
(10) Pub. No.: US 2006/0059653 A1
(43) Pub. Date: Mar. 23, 2006

(54) Truck mounted liquid concrete waste vacuum system

(76) Inventors: Kevin Mickelson, Carmichael, CA (US); Roger Engelsgaard, Citrus Heights, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/227,426

(22) Filed: Sep. 14, 2005

Related U.S. Application Data
(60) Provisional application No. 60/609,930, filed on Sep. 14, 2004.

(51) Int. Cl. C02F 1/00; E01H 1/08

(52) U.S. Cl. 15/340.1; 210/740

(57) ABSTRACT

A truck mounted liquid concrete waste vacuum system with a storage tank adapted to be used in conjunction with a watertight concrete washout bin. The concrete washout bin is configured to roll off a transport vehicle for delivery to a construction site and to contain all solid and liquid concrete washout waste from construction activities. When the concrete washout waste is to be removed from the site, the liquid concrete waste vacuum system attached to the transport vehicle is first used to remove the liquid waste from the washout bin and store it in the tank. The bin containing the remaining solid waste is loaded on the transport vehicle and taken to the treatment facility where both the solid and liquid waste is safely off-loaded.

### CROSS-REFERENCE TO RELATED APPLICATIONS

This application claims priority from U.S. provisional application Ser. No. 60/609,930 filed on Sep. 14, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to concrete washout waste, and more particularly to waste liquid associated with washout of concrete trucks and associated equipment on construction sites.

2. Description of Related Art

Construction sites have long been identified as a large contributor to urban runoff pollution if the proper pollution prevention practices are not regularly performed. Construction materials washed into the storm drain have a direct impact on local waterways and habitat living in that environment.

The most common discharge into storm drains from concrete construction activity is the residue and contaminants from washing down equipment such as concrete trucks, pumps, mixers, chutes, hand tools and wheelbarrows. Other cementitious contaminants include washout from grout, mortar and stucco. Once released into a storm drain, the solids and sediments are not easily removed and the high pH and suspended solids of the waste are extremely toxic to aquatic wildlife.

Temporary washout areas with berms, haybales, linings and catchment systems are typically used on construction sites, but with poor results. These temporary sites are prone to leaking or flooding during rains. Evaporation or leaching as a method to remove the liquid waste is not environmentally safe or practical. Dumpsters and sludge boxes are also used to contain washout waste but are prone to leaking during use or during transport.

Some concrete trucks are equipped with a reclaimer system, a temporary storage for washout waste that is returned to the batch plant for recycling. These systems require valuable time for the operator to use and need ongoing maintenance to stay operational.

On some construction sites, individual plastic bags are used to contain washout waste. These small bags, typically about 5 gallons, are time consuming to use and usually require two persons to handle during washout activities. They may be left on the jobsite for several weeks exposed to the elements, rough ground, and puncture hazards.

### BRIEF SUMMARY OF THE INVENTION

The invention is a truck mounted liquid concrete waste vacuum system with a storage tank adapted to be used in conjunction with a watertight concrete washout bin. The concrete washout bin is configured to roll off a transport vehicle for delivery to a construction site and to contain all solid and liquid concrete washout waste from construction activities. When the concrete washout waste is to be removed from the site, the liquid concrete waste vacuum system attached to the transport vehicle is first used to remove the liquid waste from the washout bin and store it in the tank. The bin containing the remaining solid waste is loaded on the transport vehicle and taken to the treatment facility where both the solid and liquid waste is safely off-loaded.

The liquid concrete waste vacuum system can also be used to periodically remove liquid concrete waste from a concrete washout bin to extend the onsite service time of the washout bin before removal.

An embodiment of the invention is a liquid concrete waste vacuum pump system coupled to a transport vehicle that comprises a tank, the tank mounted on the transport vehicle, a vacuum pump, the vacuum pump fluidly connected to the tank, a motor, the motor adapted to drive the vacuum pump, a suction hose, the hose fluidly connected to the tank, where the suction hose is adapted to move liquid concrete waste into the tank when the vacuum pump is driven by the motor.

An aspect of the invention is a hatch, the hatch mounted in the tank, a discharge line, the discharge line mounted in the hatch, where the hatch and the discharge line are adapted to remove liquid concrete waste from the tank.

A further aspect of the invention is where the vacuum pump and the motor are mounted on the tank.

Another aspect of the invention is where the vacuum pump and the motor are mounted on the transport vehicle.

Another aspect of the invention is a method for removing concrete washout waste from a construction site that comprises providing a transport vehicle with a liquid concrete waste vacuum pump system and a concrete washout bin, transporting the concrete washout bin to the construction site with the transport vehicle, filling the concrete washout bin with concrete washout waste, removing the liquid concrete waste in the concrete washout bin with the liquid concrete waste vacuum pump system leaving solid concrete washout waste in the concrete washout bin, and transporting the liquid concrete waste in the liquid concrete waste vacuum pump system and the solid concrete waste in the concrete washout bin to a treatment facility with the transport vehicle.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a perspective view of a liquid concrete waste vacuum system mounted on a transport vehicle.

FIG. 2 is a cross section view of the liquid concrete waste vacuum system in FIG. 1 taken at line 2-2.

FIG. 3 is a perspective view of the transport vehicle with a liquid concrete waste vacuum system shown in FIG. 1 servicing a concrete washout bin.

### DETAILED DESCRIPTION OF THE INVENTION

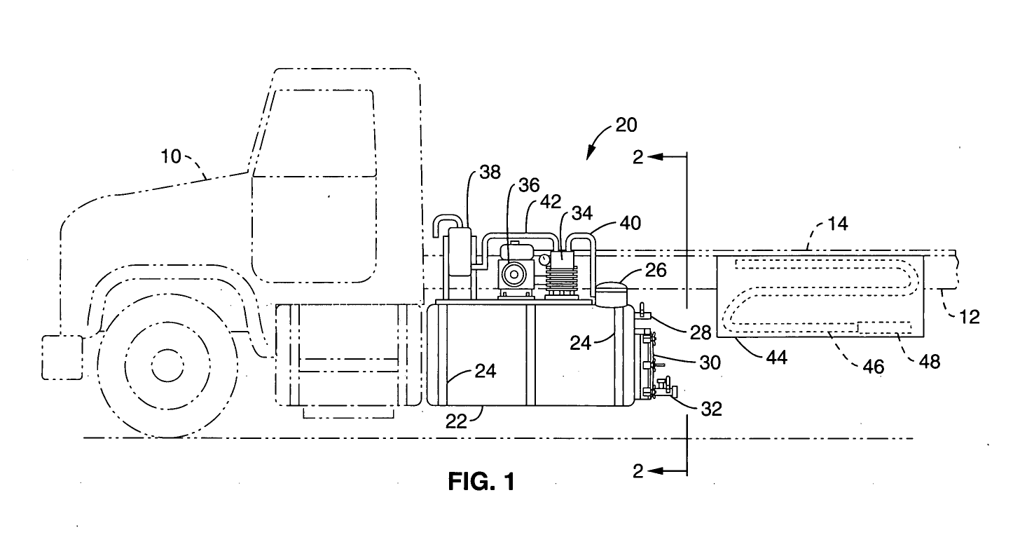

Referring more specifically to the drawings, for illustrative purposes the present invention is embodied in the apparatus generally shown in FIG. 1 through FIG. 3. It will be appreciated that the apparatus may vary as to configuration and as to details of the parts, and that the method may vary as to the specific steps and sequence, without departing from the basic concepts as disclosed herein.

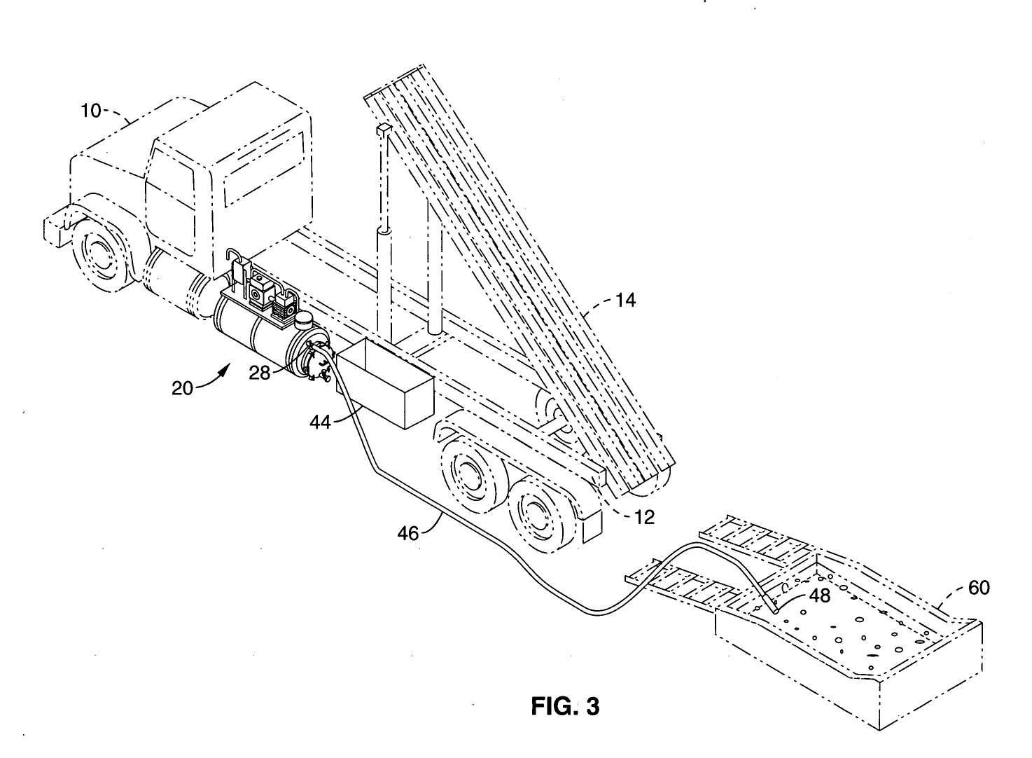

FIG. 1 illustrates a transport vehicle 10 equipped with frame 12 and elevating slide rack 14 for handling skid loaded containers such as concrete washout bins (see FIG. 3). A liquid concrete waste vacuum system 20 is mounted to truck 10 and consists of a tank 22 mounted to truck frame 12 with saddle clamps 24. Tank 22 has top hatch 26, here shown towards the rear of tank 22, suction line and valve 28 and rear hatch 30. A discharge line and valve 32 is mounted on rear hatch 30.

A vacuum compressor 34 is coupled to an engine or motor 36 mounted atop tank 22. Vacuum compressor 34 exhausts to an oil catch muffler 38 through exhaust tube 42 and generates a vacuum through load tube 40 coupled to tank 22 at top hatch 26. A hose storage box 44 is attached to frame 12 and contains suction hose 46 and wand 48.

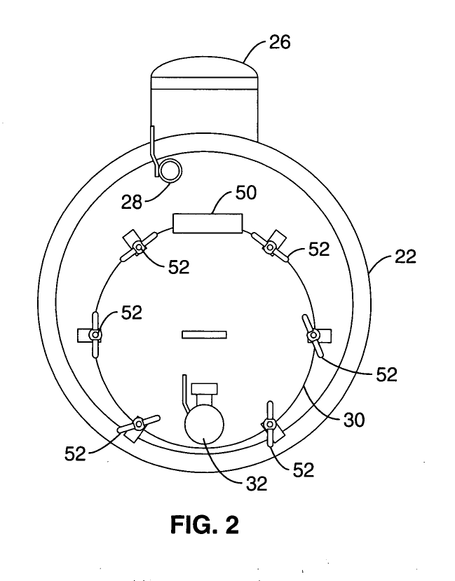

FIG. 2 illustrates the end of tank 22 taken at line 2-2 in FIG. 1. Rear hatch 30 has discharge line and valve 23 positioned at the bottom. A hinge 50 is positioned at the top of rear hatch 30 to provide access to tank 22 for cleaning. Clamps 52 keep rear hatch 30 closed and sealed during use.

In one embodiment, tank 22 is about 300 gallons and is made of 3/16 inch carbon steel. Tank 22 is about 30 inches in diameter, about 87 inches long and is equipped with a rear access hatch 30 of about 21 inches in diameter. A discharge line and valve 32 is positioned near the bottom of the hatch and is about 3 inches in diameter discharge line with valve. Suction line and valve 28 is about 2 inches and couples to a 2 inch hose 46. The tank is adapted with a 2 inch diameter exhaust tube 42 and a 1½ inch diameter load tube 40 with a shut off valve. The tank also has about a 5 inch sight glass.

Referring to FIG. 1, an engine 36 of about 8 horsepower coupled to vacuum pump 34. The engine is preferably gas but can be electric or powered by a vehicle drive take off. The vacuum pump has an oil catch muffler 38 and vacuum relief valve, pressure relieve valve and associated fittings and gauges. In one embodiment, a float valve is mounted in the tank and disengages the vacuum system when the tank is about full.

In a further embodiment, the oil catch muffler 38 has a 1½ inch fitting, the vacuum relief has a 1¼ inch fitting and the pressure relief has a 1¼ inch fitting.

In a still further embodiment, the tank has a hatch on the top 26 which is also connected to the vacuum pump.

In another mode, the engine and vacuum pump assembly is mounted directly or partially on transport vehicle 10. In one example of this mode, the engine and vacuum pump is mounted on the opposite side of the truck frame from the tank.

FIG. 3 illustrates vehicle transport 10 servicing a concrete washout bin 60 containing concrete and liquid concrete waste. Hose 46 is connected to tank 22 at suction line and valve 28. Wand 48 coupled to hose 46 is used to access liquid in concrete washout bin 60.

In one mode, wand 48 has a shut off valve. In another mode, wand 48 is used to keep the suction below the surface of the liquid waste and to access the liquid waste in pockets between the solid materials. In a further mode, wand 48 is equipped with a screen to keep small solids like gravel from entering the suction hose or the liquid waste tank.

During retrieval of a concrete washout bin containing washout waste, the liquid concrete waste vacuum system 20 is used to remove the liquid waste from the bin before loading onto the transport vehicle 10. Both the liquid waste in the tank and the solid waste in the concrete washout bin are transported to the treatment facility at the same time. After discharge of liquid waste through the discharge line 32 in to a treatment facility, the rear hatch 30 can be open to wash out the tank and remove remaining debris.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A liquid concrete waste vacuum pump system coupled to a transport vehicle comprising:
a tank, said tank mounted on said transport vehicle;
a vacuum pump, said vacuum pump fluidly connected to said tank;
a motor, said motor adapted to drive said vacuum pump; and
a suction hose, said hose fluidly connected to said tank;
wherein said suction hose is adapted to move liquid concrete waste into said tank when said vacuum pump is driven by said motor.

2. A liquid concrete waste vacuum pump system as recited in claim 1, further comprising:
a hatch, said hatch mounted in said tank; and
a discharge line, said discharge line mounted in said hatch;
wherein said hatch and said discharge line are adapted to remove liquid concrete waste from said tank.

3. A liquid concrete waste vacuum pump system as recited in claim 1, wherein said vacuum pump and said motor are mounted on said tank.

4. A liquid concrete waste vacuum pump system as recited in claim 1, wherein said vacuum pump and said motor are mounted on said transport vehicle.

5. A method for removing concrete washout waste from a construction site, comprising:
providing a transport vehicle with a liquid concrete waste vacuum pump system and a concrete washout bin;
transporting said concrete washout bin to the construction site with said transport vehicle;
filling said concrete washout bin with concrete washout waste;
removing the liquid concrete waste in said concrete washout bin with said liquid concrete waste vacuum pump system leaving solid concrete washout waste in said concrete washout bin; and
transporting the liquid concrete waste in said liquid concrete waste vacuum pump system and the solid concrete waste in said concrete washout bin to a treatment facility with said transport vehicle.
